(19) United States
(12) Patent Application Publication
(10) Pub. No.: US 2012/0137767 A1
(43) Pub. Date: Jun. 7, 2012

(54) TIME DOMAIN REFLECTOMETRY DEVICE AND METHOD

(75) Inventor: Emanuel H. Silvermint, Shoreview, MN (US)

(73) Assignee: ATEK Products, LLC, Brainerd, MN (US)

(21) Appl. No.: 13/312,795

(22) Filed: Dec. 6, 2011

Related U.S. Application Data
(60) Provisional application No. 61/420,203, filed on Dec. 6, 2010.

(51) Int. Cl. G01F 23/22

(52) U.S. Cl. 73/290 R

(57) ABSTRACT

Time domain reflectometers are described that include a sensor circuit, a feed line, a lead line, and a signal generator. The feed line and lead line are configured such that when a signal propagates through the feed line and the guide line at least one of the reflected signals of the plurality of reflected signals is delayed beyond full measurement range of the apparatus so as to prevent the reflected signal from being possibly sensed.

### CLAIM OF PRIORITY

This patent application claims the benefit of priority, under 35 U.S.C. Section 119(e), to U.S. Provisional Patent Application Ser. No. 61/420,203, entitled “METHOD OF REMOVING MULTI-TRANSIT REFLECTIONS AS WELL AS DEVICES AND MANUFACTURING METHODS THEREOF,” filed on Dec. 6, 2010 (Attorney Docket No. 2679.007US1), which is hereby incorporated by reference herein in its entirety.

### TECHNICAL FIELD

Various embodiments described herein relate to, but not by way of limitation, apparatuses, systems, and methods associated with time domain reflectometry (TDR).

### BACKGROUND

Time domain reflectometry (TDR) has many applications including level measurement of liquids and other substances in tanks, reservoirs, or vessels of various heights, inventory management, cable integrity analysis, custody transfer, leak detection, and many others.

Some of these applications demand high accuracy and ability to reliably perform robustly even in low dielectric constant materials contained in tall tanks. Devices and methods that are able to conform to stringent demands are typically expensive, demand relatively high level of electrical power, and, hence, cannot be powered by low power, small batteries. Also, some locations in which TDR may be employed are hazardous. Some of the TDR devices may be required to pass certification testing for intrinsically safe equipment. Devices and methods with improved performance, ability to measure depth in both isotropic and anisotropic substances, as well as featuring intrinsically safe in-situ battery replacement, lower power consumption, and lower cost are desired.

### BRIEF DESCRIPTION OF THE DRAWINGS

FIG. 1 is a depiction of an example apparatus according to an embodiment of the invention.

FIG. 2 is a time-extended depiction of pulsed and reflected signals according to a prior TDR system.

FIG. 3 is a time-extended depiction of pulsed and reflected signals according to an embodiment of the invention.

FIG. 4 is a block diagram depiction of an example method according to an embodiment of the invention.

FIG. 5 is a graph of feed line length and lead line length vs. feed cable delay according to an example embodiment of the invention.

### DETAILED DESCRIPTION

In the following detailed description of the invention, reference is made to the accompanying drawings that form a part hereof and in which are shown, by way of illustration, specific embodiments in which the invention may be practiced. These embodiments are described in sufficient detail to enable those skilled in the art to practice the invention. Other embodiments may be utilized and structural, logical, and electrical changes may be made.

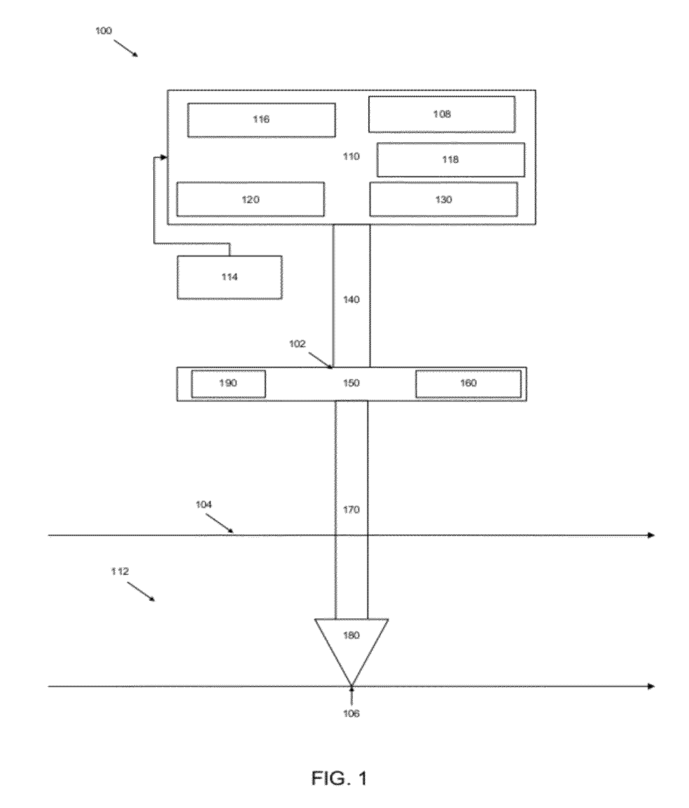

FIG. 1 is an apparatus, 100, according to an example embodiment of the present invention. Circuit, 110, which may be a printed circuit board (PCB) with electric and electronic components, and traces, may contain a sensor, 120, and a signal generator 130. According to an example embodiment circuit, 110, may optionally include circuitry, 108, capable of detecting and compensating for noise realized in apparatus, 100. Sensor, 120, may be a TDR sensor according to an example embodiment. Sensor, 120, may also be any sensor capable of detecting an electrical, acoustic, or light signal. A feed line, 140, may be coupled to the circuit, 110. Feed line, 140, may be coax, optical fiber, any material capable of transmitting an acoustic signal, any material capable of transmitting an electrical signal, or any material capable of transmitting a light signal. The feed line, 140, may be coupled to an optional interface circuit, 150. Interface circuit, 150, may include an impedance matching network, 160. Interface circuit, 150, may include circuitry, 190, capable of detecting and compensating for noise realized in apparatus, 100. According to an example embodiment, interface circuit, 150, may include an impedance matching network, 160. Impedance matching network, 160, may be a combination of capacitors, inductors, resistors, pulse transformers, and other electric and electronic components. The optional interface circuit, 150, may be coupled to lead line, 170.

The feed line, 140, with or without optional interface circuit, 150, is coupled to lead line, 170, forming a line junction, 102. Feed line, 140, has a characteristic feed line impedance. Lead line, 170, has a characteristic lead line impedance. In an example, a uniform, parallel twin-lead transmission line with a plastic insulator between the leads has a characteristic lead line impedance. The characteristic impedance of a lossless transmission line in the absence of reflection in the line is a real number measured in Ohms. The characteristic feed line impedance may be greater than the characteristic lead line impedance. The characteristic lead line impedance may be greater than the characteristic feed line impedance. The optional interface circuit, 150, has a characteristic interface circuit impedance. The characteristic lead line impedance may be equal to the characteristic feed line impedance but different from the characteristic interface circuit impedance. The characteristic feed line impedance and the characteristic lead line impedance may be substantially different. The characteristic feed line impedance may be about 10-100 Ohms. The characteristic lead line impedance may be about 30-800 Ohms. The characteristic feed line impedance and the characteristic lead line impedance define an impedance mismatch (i.e. the difference in value between the characteristic lead line impedance and the characteristic feed line impedance). The impedance matching network, 160, may compensate for the impedance mismatch. According to an example embodiment, the impedance mismatch may be increased or decreased by the impedance matching network, 160. In an example embodiment, a signal generated by signal generator, 130, while passing through the impedance matching network, 160, (i.e. discontinuity point) creates a fiducial pulse that serves as a reference (“zero”) point for measurement of delay of a returned reflected pulse.

Lead line, 170, may be optical fiber, any material capable of transmitting an acoustic signal, any material capable of transmitting an electrical signal, or any material capable of transmitting a light signal. Lead line, 170, may be a twin lead guide serving as a waveguide. Lead line, 170, may be manufactured using Teflon insulation. Lead line, 170, may be coupled to a weight, 180. The weight, 180, may be capable of ensuring that lead line, 170, remains substantially straight and vertical. Weight, 180, optionally may ensure that lead line, 170, is electrically terminated. Weight, 180, may be substantially close to the bottom of a substance, 112. The substance, 112, may be chosen from a variety of bulk solids, powders, liquids, emulsions, substance mixtures, feed, or gases. Substance, 112, may be contained in a holding tank, reservoir, vessel, or silo. Depth measurements may be made on the substance, 112, to ascertain and monitor ullage values above the surface, 104, of substance, 112, while in the holding tank, reservoir, vessel, or silo. Substance, 112, may be fuel for example.

According to an example embodiment apparatus, 100, includes a wireless communication device, 116. Wireless communication device, 116, may be included in circuit, 110, coupled to circuit, 110, or connected to the apparatus, 100, in any fashion which allows the wireless communication device to receive the results of the measurements and transmit the results to at least one remote terminal. Wireless communication device, 116, is capable of communicating measurement results to remote devices so as to allow remote updates regarding the measurements. Wireless communication device, 116, is capable of remotely receiving software updates capable of calibrating, troubleshooting, and reconfiguring apparatus, 100. The software may be updated by downloading firmware to at least one microprocessor, 118, (i.e. microcontroller) that controls operation of the apparatus. Sensor, 120, may optionally be implemented using microcontroller, 118.

According to an example embodiment apparatus, 100, is capable of making measurements (e.g. ullage, depth, integrity, contour, etc.) independent of isotropic or anisotropic properties of a substance, 112. Isotropic substances have a relative permittivity that is a scalar (i.e. isotropic substances have substantially linear, substantially homogeneous responses to changes in electric field), whereas anisotropic substances have a relative permittivity that is a second rank tensor.

According to an example embodiment apparatus, 100, may receive power from a power supply, 114. The power supply, 114, may be at least one battery, or any other power supply capable of providing power to the apparatus.

According to an example embodiment the apparatus, 100, may be placed at a location at which TDR measurements are desired. The location may be a location that is considered hazardous. The apparatus, 100, may be capable of being serviced at the location in which TDR measurements are desired, including diagnostic testing of the apparatus, 100, and changing the power supply, 114.

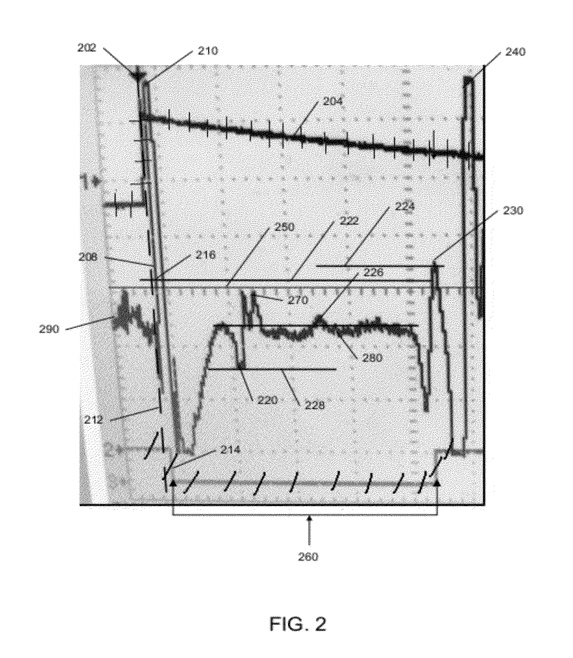

FIG. 2 shows a typical measured interval, 260, corresponding to a round trip of travelling wave, 290, of a prior TDR system. On the traveling wave 290, “zero time” of measured interval, 260, is seen at the rising edge, 208 of a large positive peak; the “fiducial zero complex”, 210 (the “complex”). The complex, 210, is generated due to reflection of the wave caused by an impedance mismatch.

The traveling wave 290, is further seen providing the “reflection of interest” at the end of measured interval, 260, as a positive peak, 230. In one embodiment of the present invention, the peak 230 may represent the wave reflection at the interface 104 of air and fuel in a storage tank. If an example tank would be empty, the width of measured interval, 260, would be longer. The interval, 260, would be terminated by reflection 240. The detection threshold, 250, is set higher than the maximum peak, 270.

Sweep time scale is set by a circuit that produces sweep frames represented by trace, 204. Each measurement frame and sweep starts with reset at rising edge, 206, of the trace, 204. (The oscilloscope's trigger arrow, 202, is indicated as occurring at the same time.) TDR assembles waveform of travelling wave, 290, from individual sampling points, where each point is obtained by a technique similar in operation to distance measuring by radar.

There is a small interval between circuit reset, 212, and zero measurement time, 214. Reset, 212, corresponds to event, 206, which is traced by line, 212.

To detect a reflected echo, threshold detection level (detection threshold), 222, is set above noise threshold, 250, and below echo peak, 230. The interval, 260, is dictated by detecting rising edges of peaks 210 and 230 intercepted by threshold level 222. Zero-time point, 214, is derived from the intersection of the rising edge of peak, 210, and detection threshold, 222, which is derived from point, 216. The intercept of rising edge of feature, 230, and detection threshold, 222, is also traced down for clarity.

Line, 226, is representative of a desired baseline of the travelling wave, 290. The magnitude of the useful signal peak 230 becomes reduced in substances with low dielectric constants as well as in devices that need to have long waveguides (i.e. a substance in a tall tank).

The double-peak, 270, is an artifact; it is a phantom multi-transit reflection that reduces available dynamic range. Noise threshold, 250, is significantly above a position of desired baseline, 226, of the signal.

The reflected signal (i.e. useful peak), 230, at any point of baseline, 226, is always superimposed on the deviation level from average baseline value, 226. This is true even for phantom type signals like the 220/270 signature. An issue is that if 230 would happen to be at the level 228 of the valley 220 the gap between levels 226 and 228 exceeds the safety gap between levels 224 and 222. This is the case of “false negative”, as the peak of signal 230 would be lower than threshold detection level 222 due to the superposition at the valley 228. This may trigger an empty vessel measurement in a tank level gauge example.

An opposite situation would occur if, for example, random noise would be added to one of the peaks, 270, thus pushing a peak over the detection threshold, 222. In such a case, a vessel that otherwise might need a refill may report a false positive.

To consider performance over full measurement range (from “zero time,” 214, to “end of probe time” that would correspond to the detection of rising edge of the feature, 240), “the available dynamic range of TDR at a specific point of measurable range” should be calculated for the worst case. For the waveform, 290, depicted in FIG. 2, this is described as “available dynamic range of TDR at a specific point of measurable range”, or magnitude gap (difference) between levels, 224, and 222, less the gap (difference) between levels, 226, and 228.

Symbolically available dynamic range is defined as: D.R.=gap1(224−222)−gap2(226−228). Measurement robustness is defined here as: M.R.=D.R.−K, where K is a selected safety coefficient. K may be 50 mV, for example. Available dynamic range is synonymous with “device sensitivity”.

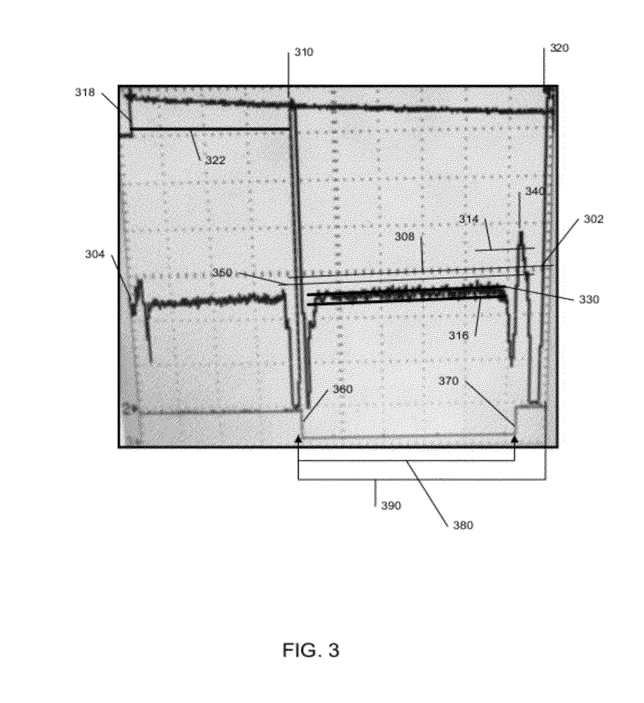

FIG. 3 shows a typical waveform of an example embodiment of the present invention. Similar, but not the same as 290, FIG. 3 shows a traveling wave, 304. Similar to, but not the same as 260, FIG. 3 shows a measured time interval, 380. A pulse produced by signal generator, 130, creates a traveling wave, 304, that propagates through a feed line, 140, and a lead line, 170. When the wave is at or near a junction, 102, (i.e. the line junction, or cable junction) of the feed line, 140, and the lead line, 170, a reflected signal is created. This reflected signal is created as a result of a discontinuity (i.e. an impedance mismatch) reflecting a portion of the traveling wave being reflected back.

For a variety of practical considerations, including TDR advancements and production tolerances, the waveform baseline, 330, should be as flat as possible in the measurement interval, so the threshold detection level, 308, may be lowered and weaker reflections could be detected.

The magnitude of useful peak signal, 340, becomes reduced in substances, 112, with low dielectric constants as well as in devices that need to have long lead lines (i.e. waveguides), 170. The difference between a reliably detectable level, 314, and the threshold detection line, 308, is “the available dynamic range of TDR at a specific point of a measurable range.”

An electromagnetic signal, 304, created by signal generator, 130, propagates through feed line, 140, and guide line, 170, at about 75% of light speed. Due to the way oscilloscope circuitry operates, the sweep time of sampled waveform, as well as the time scale in FIG. 3, the wave could be about 10,000 times slower than the actual wave speed in the medium, 112.

When the travelling wave is at or near a junction, 102, (i.e. the line junction, or cable junction) of the feed line, 140, and lead line, 170, a reflected signal, 310, is created, and is reflected opposite the direction of propagation, is detected by the sensor, 120, and triggers the beginning, 360, of a measured interval, 380. The feed line, 140, and lead line, 170, are configured so as to stop at least one of the reflected signals, for example at least one of the reflected signals beginning around 220 and continuing until at least 280, from being sensed in the measured interval, 380. The reflected signals, according to an example embodiment, have a substantially flat base line, 330, within the measured interval, 380. At or near a surface of a substance, 104, a portion of the generated signal is reflected, 340, which may trigger an end, 370, of the measured interval, 380, according to an example embodiment. According to an example embodiment the time between the beginning, 360, and the end, 370, of the measured interval, 360, helps determine a measurement of the substance, 112, like depth for example. If a depth of the substance, 112, is being measured and there is substantially no substance left to be measured (for example, if a substance is being held in a tank and the tank is empty) the detected, reflected signal, 320, from at or near the end, 106, of the lead line, 170, may trigger an end, 302, of a maximum measured interval, 390. According to an example embodiment the time between reflected signals, 310 and 320, approximates a maximum measured interval, 390. In an example embodiment at least one of the reflected signals, for example at least one reflected signal beginning near 220 ad continuing to at least 280, is not detected within the measured interval, 380, or alternatively the maximum measured interval, 390.

In one embodiment of the present invention, the peak, 340, may represent a wave reflection at the interface, 104, of air and fuel in a storage tank. If tank would be empty, the pulse, 380, would be terminated by reflection, 320, which corresponds to the end of guide line, 170, (i.e. guide probe) at its interface with weight, 180, depicted as measurement interval, 390.

Peak, 310, is a first reflection of the wave traveling in opposite direction; from the junction, 102, back through the feed line, 140, toward circuit, 110. At or around the time the travelling wave encounters another impedance discontinuity, for example at the beginning of the feed line, 140, and circuit, 110, the prior system detects double-peak, 270, of the 220/270 signature, which is removed according to embodiments of the present invention.

According to an example embodiment, removing at least one reflected signal from a measured interval, 380, or a maximum measured interval, 390, of a sensor may increase accuracy, measurement robustness, device sensitivity, and dynamic range, 306, of a TDR system by decreasing the chance of a false trigger (i.e. a detected signal above noise threshold, 350, occurring in the measured interval), 306. Dynamic range, according to FIG. 3, is defined as: D.R.=gap3(314−308)−gap4(330−316). A larger dynamic range helps ensure accurate measurements by decreasing the chance of false triggering, chances of both false positive and false negative triggering are reduced. A larger dynamic range helps ensure, better linearity, at least in part, due to baseline, 330, flattening. The length of feed line, 140, may be extended to help increase an accuracy or dynamic range of the TDR apparatus. According to another example embodiment, at least one reflected signal may be substantially removed from the measurement interval, either 380 or 390, of the system, by configuring the lead line length, feed line length, or both. Detection threshold, 308, may be higher than noise threshold, 350.

In an example embodiment, the interval between reset, at 212, and zero measurement time, 214 of a prior system, may be substantially increased to the interval between circuit reset, 318, and zero time measurement (i.e. beginning of measurement interval), 360 of the present system. This increased time, 322, may help remove artifacts for example the artifacts appearing between 220 and 280 of the example prior system, from a measurement interval, for example either 380 or 390.

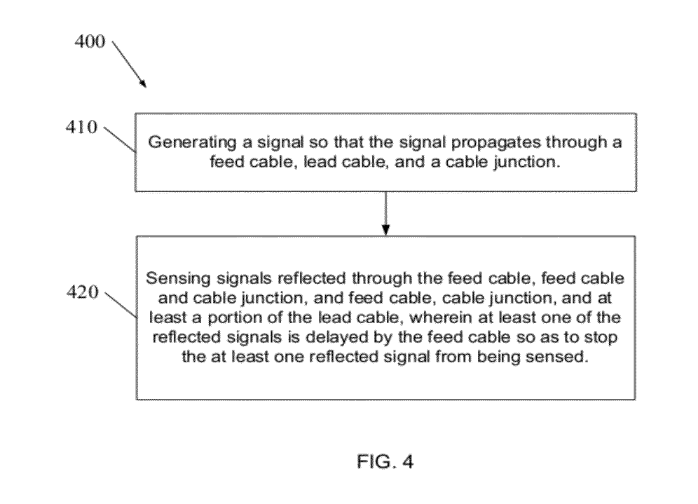

FIG. 4 depicts a method, 400, according to an example embodiment of the invention. According to an example embodiment a signal is generated, 410. The signal may be an acoustic signal, electrical signal, light signal, or any other type of signal capable of creating reflected signals at least at or near an interface of mediums with different relative permittivities. Signals are sensed that have reflected through at least a portion of one of the mediums, 420. In an example embodiment at least one of the reflected signals is stopped from being sensed, 420. In an example embodiment at least one of the reflected signals is stopped from being sensed in a measured interval of a sensor, 420.

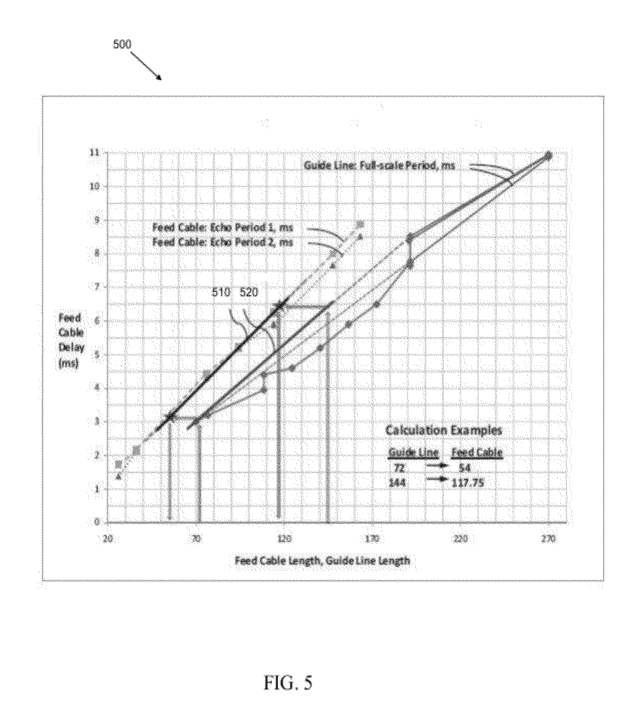

FIG. 5 depicts a graph of feed cable length and guide line length vs. feed cable delay, 500, with example feed cable length and guide line length calculations according to example embodiments of the invention. According to an example embodiment a guide line (e.g. lead line) length is chosen from guide line nomogram, 520, and a corresponding feed cable length is chosen according to a feed cable nomogram, 510. According to an example embodiment a feed cable (e.g. feed line) length is chosen from feed cable nomogram, 510, and a corresponding guide line length is chosen according to a guide line nomogram, 520. According to an example embodiment choosing guide line length and feed cable length according to nomograms, 510 and 520, may provide for substantially linear measurements (e.g. a substantially linear depth measurement). According to an example embodiment using guide line length and corresponding feed cable length according to respective nomograms, 510 and 520, in an apparatus, 100, provides an apparatus such that at least one reflected signal of a plurality of reflected signals, for example at least one of the reflected signals beginning around 220 and continuing until at least 280, is delayed so as to be removed from a measured interval, 380, or a maximum measured interval, 390, of a sensor, 320. According to an example embodiment using a guide line length and a corresponding feed cable length according to respective nomograms, 510 and 520, in an apparatus, 100, provides an apparatus such that reflected signals, sensed within a time corresponding to a measured interval, 380, or a maximum measured interval, 390, of a sensor, has a substantially flat base line, 330, within the measured interval, 380, or the maximum measured interval, 390.

The guide line length and feed cable length of FIG. 5 are in inches and the feed cable delay is in milliseconds, however, one of ordinary skill in the art would appreciate how to make other graphs of feed cable length and guide line length vs. feed cable delay of different scales with the help of the present disclosure.

While a number of embodiments of the invention are described, the above lists are not intended to be exhaustive. Although specific embodiments have been illustrated and described herein, it will be appreciated by those of ordinary skill in the art that any arrangement that is calculated to achieve the same purpose may be substituted for the specific embodiment shown. This application is intended to cover any adaptations or variations of the present invention. It is to be understood that the above description is intended to be illustrative and not restrictive. Combinations of the above embodiments, and other embodiments, will be apparent to those of skill in the art upon studying the above description.

What is claimed is:

1. An apparatus comprising:
a circuit including a time domain reflectometer (TDR) sensor, wherein the TDR sensor is configured to sense reflected signals and the TDR sensor is configured to have a measurement interval;
a feed line comprising a first feed line end, a second feed line end, and a feed line length, wherein the first feed line end is coupled to the TDR sensor;
a lead line comprising a first lead line end, a second lead line end, and a lead line length, wherein the first lead line end is coupled to the second feed line end so as to create a junction;
a pulse generator coupled to the feed line, wherein the pulse generator is configured to propagate a pulse through the feed line, the junction, and the lead line such that a plurality of reflected signals is created, at least one of the reflected signals corresponding to a depth of a substance in a holding tank; and
wherein the feed line length and the lead line length are configured such that at least one of the reflected signals of the plurality of reflected signals is outside the measurement interval so as to stop the at least one reflected signal from being sensed.

2. The apparatus of claim 1, wherein the lead line length and feed line length are configured to leave the sensed reflected signals with a substantially flat base line within the measurement interval.

3. The apparatus of claim 1, wherein feed line length is extended to increase an accuracy and a dynamic range of the TDR apparatus.

4. The apparatus of claim 1, wherein the lead line length and the feed line length are configured to provide a substantially linear depth measurement.

5. The apparatus of claim 1, wherein the circuit is configured to calculate an average noise of the apparatus and compensate the reflected signals according to the average noise.

6. The apparatus of claim 1, wherein a wireless communication device is coupled to the circuit.

7. The apparatus of claim 1, wherein the apparatus is capable of measurements independent of an isotropic or anisotropic property of a material being measured.

8. The apparatus of claim 1, wherein the feed line is made of a first conducting material with a first characteristic impedance and the lead line is made of a second conducting material with a second characteristic impedance, wherein the first characteristic impedance is different than the second characteristic impedance.

9. The apparatus of claim 1, wherein the feed line is made of a first conducting material with a first characteristic impedance and the lead line is made of a second conducting material with a second characteristic impedance, wherein the first characteristic impedance is lower than the second characteristic impedance.

10. The apparatus of claim 9, wherein the feed line is made of a first conducting material with a first characteristic impedance and the lead line is made of a second conducting material with a second characteristic impedance, wherein the first characteristic impedance is between about 10 and 100 Ohms.

11. The apparatus of claim 9, wherein the feed line is made of a first conducting material with a first characteristic impedance and the lead line is made of a second conducting material with a second characteristic impedance, wherein the second characteristic impedance is between about 30 to 800 Ohms

12. The apparatus of claim 8, wherein the pulse generator is configured to generate an electric pulse.

13. The apparatus of claim 1, wherein the apparatus is capable of being serviced without removing the apparatus from a location in which the apparatus is being used.

14. The apparatus of claim 1, wherein the feed line length is proportional to the lead line length.

15. The apparatus of claim 1, wherein the apparatus is configured to measure a depth of material independent of a relative permittivity of the material.

16. The apparatus of claim 1, further comprising a power supply coupled to the TDR sensor.

17. The apparatus of claim 17, wherein the power supply comprises at least one battery.

18. A method comprising:
generating a signal so that the signal propagates through a feed line, lead line, and a junction; and
sensing signals reflected through the feed line, feed line and junction, and feed line, junction, and at least a portion of the lead line, wherein at least one of the reflected signals is delayed by the feed line so as to stop the at least one reflected signal from being sensed.

19. An apparatus comprising:
a sensor, wherein the sensor is configured to sense a plurality of reflected signals and the sensor is configured to have a measurement interval;
a feed line comprising a first feed line end, a second feed line end, and a feed line length, wherein the first feed line end is coupled to the sensor;
a lead line comprising a first lead line end, a second lead line end, and a lead line length, wherein the first lead line end is coupled to the second feed line end so as to create a line junction;
a pulse generator coupled to the feed line, wherein the line generator is configured to propagate a pulse through the feed line, the line junction, and the lead line such that a plurality of reflected signals is created; and
wherein the feed line length and the lead line length are configured such that at least one of the reflected signals of the plurality of reflected signals is outside the measurement interval so as to stop the at least one reflected signal from being sensed.

20. The apparatus of claim 20, wherein the feed line and lead line are configured to create a surface acoustic wave guide.

21. The apparatus of claim 20, wherein the feed line and lead line are conductors.

22. The apparatus of claim 20, wherein the feed line and lead line are fiber optic cables.
